(19) United States
(12) Patent Application Publication
(10) Pub. No.: US 2007/0252531 A1
(43) Pub. Date: Nov. 1, 2007

(54) Backlight device capable of increasing luminance efficiency

(75) Inventors: Hsiang-Jui Hung, Taipei City (TW); Yun-Jiun You, Taipei City (TW); Chun-San Lin, Taipei City (TW); Han-Hsun Chen, Taipei City (TW); Sun-Chen Yang, Taipei City (TW)

Correspondence Address: BIRCH, STEWART, KOLASCH & BIRCH, LLP, 8110 GATEHOUSE ROAD, SUITE 100 EAST, FALLS CHURCH, VA, 22315, US

(73) Assignee: ASUSTeK COMPUTER INC.

(21) Appl. No.: 11/790,245

(22) Filed: Apr. 24, 2007

(30) Foreign Application Priority Data
Apr. 28, 2006 (TW) 095115346

(51) Int. Cl. H05B 41/16

(52) U.S. Cl. 315/274

(57) ABSTRACT

A backlight device capable of increasing luminance efficiency includes a power transformation device having a primary end and a secondary end for transforming current received by the primary end and outputting transformed current from the secondary end. The backlight device further includes a double-wind coupling element including a first coupling element and a second coupling element coupled to terminals of the secondary end, for adjusting current between the first coupling element and the second coupling element, and a cold cathode fluorescent lamp coupled to the first coupling element and the second coupling element, for making current flowing into the cold cathode fluorescent equal to current flowing out from the cold cathode fluorescent according to adjusted current between the first coupling element and the second coupling element.

### BACKGROUND OF THE INVENTION

1. Field of the Invention

The present invention provides a backlight device capable of increasing luminance efficiency, and more particularly, a backlight device having a double-wind coupling element between an input end and an output end of a cold cathode fluorescent lamp, for equaling current between the input end and the output end.

2. Description of the Prior Art

Liquid crystal display, or LCD, monitors have advantages in comparison with cathode ray tube, or CRT, monitors, such as power-saving, lower radiation, small volume, etc. Therefore, the LCD monitors have been the mainstream display devices. As LCD technology is being upgraded, prices of the LCD monitors are reduced, so that the LCD monitors become more popular and are developed toward large-size applications. However, a large-size LCD monitor requires an efficient cold cathode fluorescent lamp, or Cold Cathode Fluorescent Lamp (CCFL), as a backlight source.

To emit light, the CCFL is driven by a high voltage between two ends of the CCFL to arouse mercury vapor inside the CCFL to a high energy level. As the aroused mercury vapor returns to an initial state from the high energy level, ultraviolet is generated. Then, ultraviolet is transformed to visible light through phosphorescence material on the inside surface of the CCFL.

In general, the CCFL is driven by a high-voltage AC power source. Owing to AC power, leakage current is generated and flees hither and thither in the backlight system, causing a high-voltage side of the CCFL brighter than a low-voltage side of the CCFL. Meanwhile, leakage current cannot be used for driving CCFL, causing heat dissipation and decreasing luminance efficiency of the CCFL, and especially a longer CCFL.

Please refer to FIG. 1, which illustrates a schematic diagram of a backlight device 10 of a prior art flat plane display, or FPD, monitor. In FIG. 1, the power controller 100 provides AC power to a CCFL 104 through a transformer 102, and the CCFL 104 emits light according to current provided by the transformer 102. Since a terminal of the CCFL 104 is coupled to a high AC power source provided by the transformer 102 and another terminal is coupled to a system ground, an electromagnetic field gradient between the terminals of the CCFL causes a gradual luminance phenomenon. As shown in FIG. 1, parasitic capacitance is between the CCFL 104 and the system ground, and causes leakage current from the CCFL 104 to the system ground, and decreases luminance efficiency.

In short, other than the gradual luminance phenomenon of the CCFL 104, the parasitic capacitance causes leakage current and decreases luminance efficiency of the CCFL 104.

### SUMMARY OF THE INVENTION

It is therefore a primary objective of the claimed invention to provide a backlight device capable of increasing luminance efficiency.

According to the claimed invention, a backlight device capable of increasing luminance efficiency comprises a power transformation device having a primary end and a secondary end for transforming current received by the primary end and outputting transformed current from the secondary end. The backlight device further comprises a double-wind coupling element comprising a first coupling element and a second coupling element coupled to terminals of the secondary end, for adjusting current between the first coupling element and the second coupling element, and a cold cathode fluorescent lamp coupled to the first coupling element and the second coupling element, for making current flowing into the cold cathode fluorescent equal to current flowing out from the cold cathode fluorescent according to adjusted current between the first coupling element and the second coupling element.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a backlight device of a prior art flat plane display.

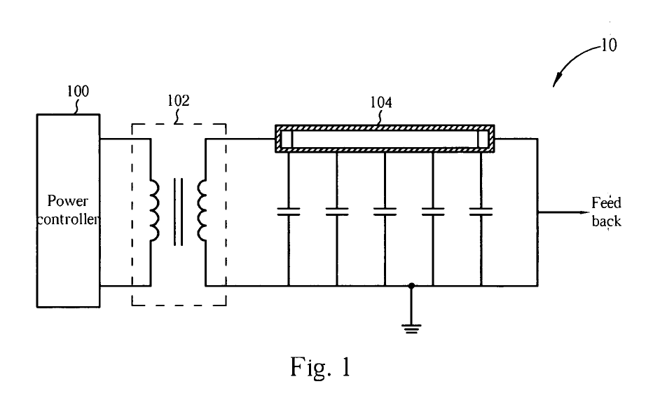

FIG. 2 illustrates a schematic diagram of a backlight device capable of increasing luminance efficiency in accordance with the embodiment of the present invention.

### DETAILED DESCRIPTION

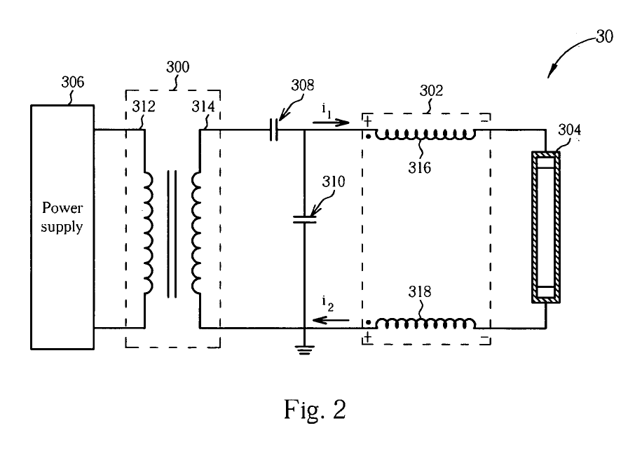

Please refer to FIG. 2, which illustrates a schematic diagram of a backlight device 30 capable of increasing luminance efficiency in accordance with the embodiment of the present invention. The backlight device 30 includes a power transformation device 300, a double-wind coupling element 302, and a CCFL 304. The power transformation device 300 includes a primary end 312 and a secondary end 314. The power transformation device 300 receives current provided by a power supply 306 with the primary end 312, transforms received current to AC current with a suitable magnitude and phase, and outputs AC current from the secondary end 314. The backlight device 30 preferably includes capacitors 308 and 310, utilized for filtering and shaping AC current outputted from the secondary end 314. The double-wind coupling element 302 includes a first coupling element 316 and a second coupling element 318, utilized for realizing a current equalization transformer, or common-mode capacitors. That is, a current i₁ flowing into the first coupling element 316 is approximately equal to a current i₂ flowing out from the second coupling element 318. As a result, current flowing into the CCFL 304 is approximately equal to current flowing out from the CCFL 304, so as to decrease leakage current, increase luminance efficiency, and improve the gradual luminance phenomenon.

Through the double-wind coupling element 302, current flowing into the CCFL 304 is approximately equal to current flowing out. Note that, polarity of a terminal coupled to the CCFL in the first coupling element 316 is same as that in the second coupling element 318 as symbols + and − shown in FIG. 2. In addition, numbers of turns of the second coupling element 318 and the first coupling element 316 can be adjusted to control the current i₂ to gain an optimal backlight source based on different applications. For example, when the number of the turns of the second coupling element 318 is slightly greater than that of the first coupling element 316, the current i₂ is slightly greater than the current i₁. When the number of the turns of the second coupling element 318 is slightly smaller than that of the first coupling element 316, the current i₂ is slightly smaller than the current i₁. When the number of the turns of the second coupling element 318 is equal to that of the first coupling element 316, the current i₂ is equal to the current i₁, so as to increase luminance efficiency.

In summary, using the double-wind coupling element having two coupling elements with same turns between two terminals of the CCFL, current flowing into the CCFL is equal to current flowing out from the CCFL, so that the CCFL is free from influence of parasitic capacitance between the CCFL and the system ground. Therefore, the CCFL can emit uniform light, and luminance efficiency of the CCFL is increased.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A backlight device capable of increasing luminance efficiency, comprising a power transformation device having a primary end and a secondary end for transforming current received by the primary end and outputting transformed current from the secondary end, the backlight device further comprising:
a double-wind coupling element comprising a first coupling element and a second coupling element coupled to terminals of the secondary end, for adjusting current between the first coupling element and the second coupling element; and
a cold cathode fluorescent lamp coupled to the first coupling element and the second coupling element, for making current flowing into the cold cathode fluorescent equal to current flowing out from the cold cathode fluorescent according to adjusted current between the first coupling element and the second coupling element.

2. The backlight device of claim 1, wherein polarity of a terminal coupled to the cold cathode fluorescent lamp in the first coupling element is same as that in the second coupling element.

3. The backlight device of claim 1, wherein a number of turns of the first coupling element is equal to the second coupling element.

4. The backlight device of claim 1, wherein a number of turns of the second coupling element is greater than the first coupling element.

5. The backlight device of claim 1, wherein a number of turns of the second coupling element is smaller than the first coupling element.

6. The backlight device of claim 1 being installed in a flat plane display.

7. The backlight device of claim 1, wherein the double-wind coupling element is further utilized for adjusting current flowing into the first coupling element to make current flowing into the first coupling element equal to current flowing out from the second coupling element.

8. The backlight device of claim 1, wherein the double-wind coupling element is further utilized for adjusting current flowing into the first coupling element to control current flowing out from the second coupling element.

9. The backlight device of claim 1, wherein the cold cathode fluorescent lamp further is further utilized for making current flowing into the cold cathode fluorescent greater than current flowing out from the cold cathode fluorescent according to adjusted current between the first coupling element and the second coupling element.

10. The backlight device of claim 1, wherein the cold cathode fluorescent lamp further is further utilized for making current flowing into the cold cathode fluorescent smaller than current flowing out from the cold cathode fluorescent according to adjusted current between the first coupling element and the second coupling element.

11. The backlight device of claim 1, wherein the cold cathode fluorescent lamp further is further utilized for making current flowing into the cold cathode fluorescent slightly equal to current flowing out from the cold cathode fluorescent according to adjusted current between the first coupling element and the second coupling element.
